(19) United States
(12) Patent Application Publication
(10) Pub. No.: US 2013/0306490 A1
(43) Pub. Date: Nov. 21, 2013

(54) Nanotube Detangler

(71) Applicant: Bryan Edward Laubscher, Olympia, WA (US)

(72) Inventor: Bryan Edward Laubscher, Olympia, WA (US)

(21) Appl. No.: 13/506,754

(22) Filed: May 15, 2012

(51) Int. Cl. B03C 7/00; B01J 19/12; B01J 19/08; B01J 19/10; B82Y 35/00; B82Y 40/00

(52) U.S. Cl. 205/766; 204/230.2; 204/230.7; 977/734; 977/762; 977/773

(57) ABSTRACT

Disclosed is a Nanotube Detangler capable of aligning and ordering the constituent nanotubes, nanowires and/or nanoparticles of a filament leading to greater tensile strength of the filament and subsequent threads or structures made from it. The technique exploits ion infusion as a mechanism to force the tangle of the nanotubes, nanowires and/or nanoparticles apart. Included in the invention are alignment enhancement technologies such as heating, vibration, electromagnetic, particle bombardment and chemical means. The present invention recognizes that aligned and ordered nanotubes, nanowires and nanoparticles in a filament will increase the conductivity of the filament and enable the fabrication of electric conductors, wires and circuit components. Such breakthroughs in strength and conductivity of filaments of nanotubes, nanowires and/or nanoparticles will revolutionize life on Earth.

### BACKGROUND OF THE INVENTION

1. Field of the Invention

The present invention relates to the development of highly ordered and aligned arrangements of nanometer scale nanotubes, nanowires and nanoparticles. The current situation can be illustrated by considering the example of carbon nanotubes (CNTs).

Individual CNTs possess superior specific tensile strength properties. However, macroscopic assemblages of CNTs, such as a twisted thread, exhibit very low specific tensile strength compared to an individual CNT. Chemically, CNTs tend to be inert. The carbon atoms are tightly bound to each other, so in general, no electrons are available to bond to an outside atom or molecule. The bonding between CNTs is mediated by the Van der Waals force. To maximize the effect of this weak force, two CNTs need to be in close contact along as much of their length as possible. Indeed properly aligned, very long CNTs could, in principal, possess an attractive force greater than the bonding force between two of their carbon atoms. Therefore, to produce a macroscopic, high strength material from CNTs, the constituent CNTs need to be aligned and everywhere be in close proximity to each other.

Growth techniques for CNTs do not generally produce aligned, ordered CNTs. In the case of CNT forest growth, which is generally aligned, entanglement of the individual CNTs contributes to disordering of the CNTs during subsequent handling. Specifically, consider the situation with CNT thread fabrication. One of the convenient ways to spin thread from CNTs is to begin with an array of CNTs that have been grown as a forest on a substrate. With appropriate density and length of the grown CNTs, the CNTs can be drawn off the substrate as a filament and then spun directly into a thread. Unfortunately, the interlacing of the CNTs that facilitates drawing filaments directly from the substrate also misaligns and disorders the CNTs.

At the nanometer scale, the manipulation of a single nanotube is painstaking, time consuming and confined to the laboratory. There exists no “nanotube/nanostructure knitting machine” in which one dumps the nanoscale building blocks in one end and a macroscopic filament, thread or structural member, with the constituent CNTs aligned, comes out the other end. Therefore, a means of fully or partially aligning nanotubes and nanostructures is sought that exploits an electrical, chemical or physical process.

2. Description of the Prior Art

U.S. Pat. No. 8,101,061 describes many embodiments by using non-faradaic electrochemical charge injection (ion infusion). The abstract states: In some embodiments, the present invention is directed to processes for the combination of injecting charge in a material electrochemically via non-faradaic (double-layer) charging, and retaining this charge and associated desirable properties changes when the electrolyte is removed. The present invention is also directed to compositions and applications using material property changes that are induced electrochemically by double-layer charging and retained during subsequent electrolyte removal. In some embodiments, the present invention provides reversible processes for electrochemically injecting charge into material that is not in direct contact with an electrolyte. Additionally, in some embodiments, the present invention is directed to devices and other material applications that use properties changes resulting from reversible electrochemical charge injection in the absence of an electrolyte.

Although many, many embodiments are claimed, the applicants never mention aligning and ordering nanotubes and nanostructures. Some of the embodiments involve chemical reactions driven by the non-faradaic charging that are undesirable for producing high strength materials from pure nanotubes, nanowires and nanostructures. Also, many of the embodiments involve the retention of the charge in the electrode after the external voltage is removed, which is undesirable in high strength material fabrication. Finally, none of the embodiments claim increases in tensile strength.

U.S. Pat. No. 8,066,967 describes electrostatic forces acting upon freely suspended nanofibers in a dielectric medium. The abstract states: A system and method for the manipulation of nanofibers using electrostatic forces. The nanofibers may be provided in a liquid medium, and the nanofibers may be nano-scale (i.e. measured in nanometers). The process is sensitive to the charge properties of the nanofibers (charge could be inherent to material or the charge can be induced into the material through electrochemical means), and therefore may be used to sort or classify particles. The nanofibers may also be aligned according to electrical fields, and thus anisotropic effect exploited. Devices produced may be conductors, semiconductors, active electronic devices, electron emitters, and the like. The nanofibers may be modified after deposition, for example to remove charge-influencing coatings to further enhance their performance, to enhance their adhesion to polymers for use as composite materials or result in the adhesion of the material at the proper location on a variety of different surfaces.

The above technique requires dispersion of the nanotubes in a dielectric medium to accomplish alignment. This dispersion is a complete, extra disassembly from a filament and then would require an ordered re-assembly of the filament which may be impossible. The above technique does not use ion infusion nor can it operate on already assembled structures such as a filament of nanotubes, nanowires or nanoparticles without disassembling the structures.

U.S. Pat. No. 7,045,108 describes the growth of carbon nanotubes on a substrate and the subsequent drawing of those CNTs off the substrate in a continuous bundle. The abstract states: A method of fabricating a long carbon nanotube yarn includes the following steps: (1) providing a flat and smooth substrate; (2) depositing a catalyst on the substrate; (3) positioning the substrate with the catalyst in a furnace; (4) heating the furnace to a predetermined temperature; (5) supplying a mixture of carbon containing gas and protecting gas into the furnace; (6) controlling a difference between the local temperature of the catalyst and the furnace temperature to be at least 50.degree. C.; (7) controlling the partial pressure of the carbon containing gas to be less than 0.2; (8) growing a number of carbon nanotubes on the substrate such that a carbon nanotube array is formed on the substrate; and (9) drawing out a bundle of carbon nanotubes from the carbon nanotube array such that a carbon nanotube yarn is formed.

The technique described in the previous paragraph is a representative example of the popular and useful “forest growth” of CNTs and the drawing of a CNT bundle from the forest. It does not discuss any technique for strengthening the drawn filament or CNT yarn.

One application of ion infusion is the embodiment of torsional actuators made by a macroscopic CNT twisted thread [Foroughi, J., et al, Science, 28 Oct. 2011: 494-497]. In this application, one electrode is a twisted CNT yarn, the electrolyte is an organic acid and the other electrode is made of platinum mesh. With the application of an appropriate DC voltage, the yarn untwists as ions are driven into the twisted CNT. When the DC voltage is removed the thread tends to re-twist, although there is some dissipation as it is not infinitely repeatable.

The publication in the previous paragraph describes ion infusion operating on a macroscopic attribute of the CNT thread: the twist. The ions untwist the thread when driven by an applied voltage. Techniques are developed to make this twisting and untwisting as repeatable as possible. This publication does not address aligning or strengthening filaments from nanotubes, nanowires or particles nor maximizing the dissipation of the untwisting process so that the thread does not return to its former state.

Ion infusion is also used to stimulate muscles and other organic tissues for biological research. A broad review of the physical basis of ion infusion in the electrical stimulation of biological excitable tissues is given by Merrill, D. R., Journal of Neuroscience Methods 141 (2005) 171-198.

The publication in the previous paragraph reviews the principles of ion infusion operating on biological tissues. It is an excellent example of the breadth of the applications of ion infusion technology as well as its universality. It is unrelated to material science and nanotechnology.

### SUMMARY OF THE INVENTION

The present invention is a technique of aligning and ordering nanotubes, nanowires and nanoparticles using ion infusion. Conceptually a filament of tangled nanotubes, nanowires and/or nanoparticles is arranged as one or two electrodes in an electrolyte. An applied voltage drives ions into the filament(s) and collides with the tangled, constituent nanotubes, nanowires and nanoparticles and loosens the entanglement. Once the voltage is removed, the ions diffuse out of the filament and it returns to relaxed state with more alignment of the constituent nano-scale filament components. The aligning and ordering of the nanotubes, nanowires and nanoparticles increase the tensile strength of the filament and any thread or structures subsequently formed from the filament. Increasing the filament's tensile strength is important for creating high strength materials from the filament.

The present invention includes techniques to enhance the alignment and ordering of the nanotubes, nanowires and nanoparticles by using mechanical stretching and/or vibration, electromagnetic fields and radiation, heating/cooling, particle bombardment and chemical means.

The present invention includes the recognition that aligning and ordering nanotubes, nanowires and nanoparticles to increase tensile strength also increases the conductivity of the filament and any thread or structures subsequently formed from the filament. Increasing the conductivity is important for using nanotubes, nanowires and nanoparticles for conductors, wires, microscale and nanoscale integrated circuits, microscale and nanoscale transistors, diodes, gates, switches, resistors, capacitors, sensors and other electrical components.

### BRIEF DESCRIPTION OF THE DRAWINGS

FIG. 1 illustrates the best mode of the Nanotube Detangler technique according to the present invention.

FIG. 2 is a detail of one possible nanotube filament mount.

FIG. 3 illustrates one possible industrial-scale apparatus for the production of aligned filaments.

### DETAILED DESCRIPTION OF THE INVENTION

### 1. Definitions

Ion Infusion—When used herein shall mean electrochemical charge injection whether it is Faradaic, non-Faradaic or a combination of both phenomena.

Tangle—When used herein as a noun: the non-uniform, disordered grouping of nanotubes, nanowires, nanoparticles and/or nanoscale structures caused by the growth process, handling or other processes. When tangle is used herein as a verb: the act of grouping nanotubes, nanowires, nanoparticles and/or nanoscale structures in a disordered, non-uniform way.

Detangle—When used herein as a verb: The act of un-tangling, loosening or separating a tangle of nanotubes, nanowires, nanoparticles and/or nanoscale structures and enabling the reconfiguration into a more ordered, more uniform grouping. When used herein as a noun: The state of being un-tangled, loosened and separated, especially in the case of nanotubes, nanowires, nanoparticles and/or nanoscale structures.

Filament—When used herein as a noun: an untwisted structure of nanotubes, nanowires, nanoparticles and/or nanoscale structures, especially long thin thread-like examples.

Voltpattern—When used herein as a noun: a sequence of applied voltages, comprising all or any various combinations of direct current (DC), alternating current (AC) and periods of no applied voltage.

### 2. Best Mode of the Invention

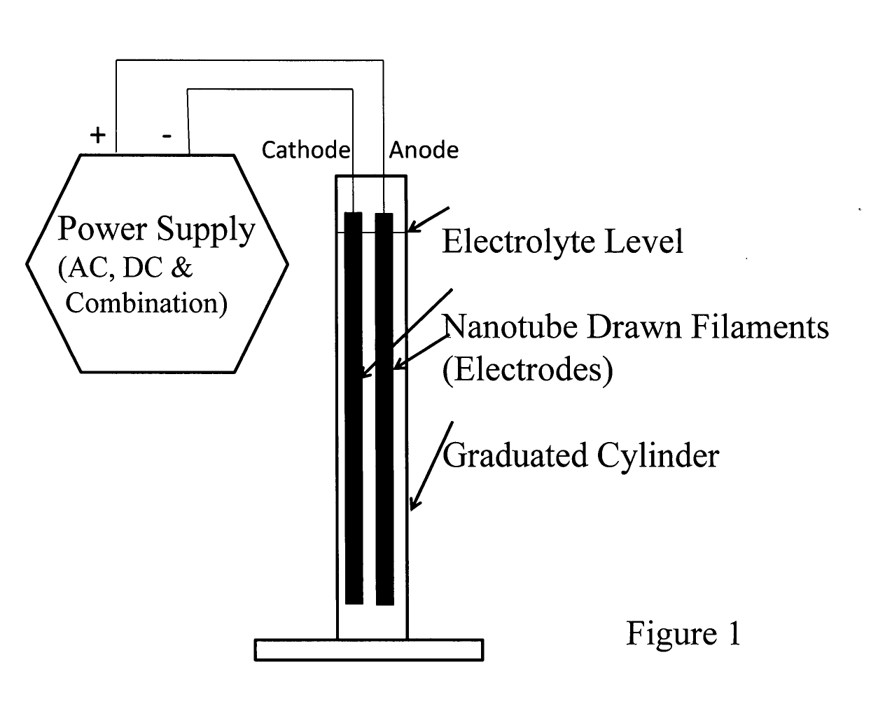

FIG. 1 illustrates the best mode contemplated by the inventor of the Nanotube Detangler according to the concepts of the present invention.

### 3. How to Make the Invention

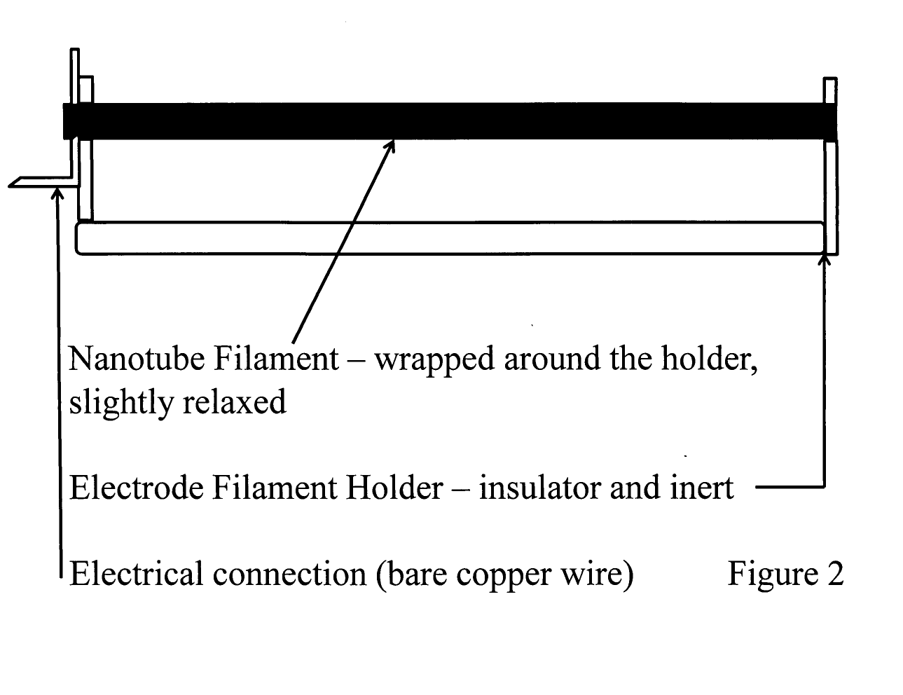

As can be amply seen in FIG. 1, two nanotube filaments comprise the anode and cathode electrodes inserted into a vessel (a graduated cylinder in the figure) that is filled with a suitable electrolyte. A voltage source is connected to the electrodes. The voltage source supplies the voltage difference required to induce a current flow between the electrodes through the electrolyte. FIG. 2 illustrates one possible configuration of a filament mounted onto a filament holder. A separate reference electrode and/or other diagnostic equipment can be used to provide measurements of the process but are not included in this figure.

This configuration of two electrodes, an electrolyte and a voltage source, is a common electrochemical experimental configuration. In the present invention the principle of ion infusion is being exploited. The ions of the electrolyte, driven by the applied voltage, are infused into the filaments, thereby detangling, to some degree, the nanotubes comprising the electrodes. In the present invention the inventor is exploiting ion infusion at the nanometer length scale as a tool to force individual and small groups of nanotubes to detangle. Conceptually, the ions are forced into the filaments and collide with tangled nanotubes. The momentum transferred by the collisions has the effect of displacing the nanotubes, thereby “loosening the knots” and detangling the filaments.

When an applied voltage is removed, the ions will tend to migrate out of the electrodes leaving the nanotubes to reassemble by way of the Van der Waals force into a more aligned and ordered configuration. The process may be repeated to increase the degree of order and alignment. The electrode polarity may be reversed to drive the infused ions out of each electrode quickly. If maintained long enough, this reversed current will drive the charged ions into the other electrode. This polarity reversal may be repeated to alternatively drive ion infusion from each charge species of ion into each electrode in a process of repeated detangling. Indeed the detangling effect of the ion infusion may be enhanced by using an AC voltage source.

An electrolyte is a substance that contains free ions. Most electrolytes are in the form of an ionic solution which comprises a solvent and an acid or salt. Potential electrolytes include solutions composed of acids including inorganic acids, organic acids and superacids as well as salts such as acid salts, basic salts and neutral salts. A common solvent in electrolytes is water but other solvents into which the acid or salt is dissolved are also possible embodiments.

An electrolyte may be chosen to maximize the momentum transfer to nanoscale structures as opposed to electrolytes that would operate on larger scale structures and thereby leave nanometer sized tangles relatively unaffected. Also, the electrolyte must not enable a significant amount of chemical reactions with the nanotubes, nanowires or nanoparticles including electrochemical or electroplating-type reactions.

A combination of electrolytes may be used to detangle a filament that consists of various types of tangles of nanotubes, nanowires or nanoparticles. That is, the detailed geometry of a given fold, knot or other entanglement or distribution of types of tangles could be optimally loosened by an appropriate choice of electrolyte.

A combination of electrolytes may be used to detangle a filament that consists of various types of nanotubes, nanowires or nanoparticles. That is, the detailed geometry of nanotubes, nanowires or nanoparticles or distribution of these constituents of the filament, could be optimally loosened by an appropriate choice of electrolyte.

Alternating the ion species infused into each electrode by reversing the polarity may provide a superior detangle process as each electrode filament is fully infused by each ion species. Each ion possesses properties that differ from the ion of opposite polarity and these differing properties could enhance detangle. This may be accomplished by a voltpattern so that the electrodes reverse polarity.

The voltpattern must be chosen so that electrolyte breakdown does not occur or disrupt the ion infusion process. For example, if the voltage is too large, an electrolyte of hydrochloric acid will cause the hydrogen ions to combine together at an electrode into molecular hydrogen and escape from the electrode vicinity (and bubble out of the water solvent) as hydrogen gas.

The voltpattern must ensure any chemical electrical potentials are surmounted so that the ions can penetrate into the filaments. For example, CNTs are hydrophobic so ions dissolved in water will require enough voltage to surmount the potential barrier between the water and CNTs.

A voltpattern including changes in magnitude, frequency and duration may be used to optimally detangle a filament that consists of various types of nanotubes, nanowires or nanoparticles or distribution of these constituents of the filament.

A voltpattern including changes in magnitude, frequency and duration may be used to detangle a filament that consists of various types of tangles of nanotubes, nanowires or nanoparticles. That is, the detailed geometry of a given fold, knot or other tangle or distribution of types of tangles could be optimally loosened by an appropriate choice of voltpattern.

Alignment enhancement techniques to enhance the detangle, alignment and ordering of nanotubes, nanowires and nanoparticles, before, during or after the ions have loosened them, may be employed. These techniques include applying vibrations to the filaments or electrolyte; applying electric and magnetic fields separate from or inclusive of the voltpattern; heating and cooling parts of the system; applying electromagnetic fields including irradiation; applying particle bombardment; and using chemicals.

Alignment techniques based on applying vibrations to the filaments include: stretching and relaxing the filaments; using sound, infrasound and/or ultrasound waves applied to the filament or as pressure waves in the electrolyte. Any combinations of these techniques are also possible embodiments. Vibrational techniques would enhance the detangle, alignment and ordering of nanotubes, nanowires and nanoparticle by mechanically working the filament's constituent components to loosen the tangles. Vibration could affect the filament alignment and ordering by inducing forces to align the nanotubes, nanowires and nanoparticles with the vibrations.

Alignment techniques based on applying electromagnetic fields include: static or time varying electric fields; static or time varying magnetic fields; laser induced electromagnetic fields; electromagnetic wave irradiation of any wavelength; or a combination of these; whether separate or inclusive of the voltpattern circuit. Electromagnetic techniques would enhance the detangle, alignment and ordering of nanotubes, nanowires and nanoparticles by exploiting the electronic nature of the filament's constituent components and induce forces that would mechanically work the filament's constituent components to loosen the tangles. Charge distributions along the nanotubes, nanowires and nanoparticles could be affected by the electromagnetic fields thereby inducing forces to align these constituents with the field.

Alignment techniques based on applying particle bombardment include: microscopic, molecular, atomic, electron and subatomic particles. Particle bombardment techniques would enhance the detangle, alignment and ordering of nanotubes, nanowires and nanoparticles by colliding with the filaments and induce forces that would mechanically work the filament's constituent components to loosen the tangles.

Alignment techniques based on applying heating and/or cooling include: heating and/or cooling of the electrolyte; heating and/or cooling of the electrode; laser induced heating; electromagnetically induced heating; or a combination of these. Heating and cooling techniques would enhance the detangle, alignment and ordering of nanotubes, nanowires and nanoparticles by creating expansion and/or contraction thereby inducing forces that would mechanically work the filament's constituent components to loosen the tangles.

Alignment techniques based on using chemicals could enhance the detangle, alignment and ordering of nanotubes, nanowires and nanoparticles by modifying the effect of the ions colliding with the filaments and loosening the tangles.

A consequence of aligning and ordering nanotubes, nanowires and nanoparticles is that the conductivity of a resulting filament or thread will increase. This increased conductivity is important for using nanotubes, nanowires and nanoparticles for conductors, wires, microscale and nanoscale integrated circuits, microscale and nanoscale transistors, diodes, gates, switches, resistors, capacitors, sensors and other electrical components.

Indeed, a given conductivity value could be achieved by adjusting the degree of detangle. The resulting filament and/or any thread or structure made from the filament could then possess a desired conductivity. To achieve this tuning, the conductivity of the filament can be measured either intermittently or continuously throughout the detangle operation to determine the filament's conductivity and to gauge the degree of detangle. This measurement may be made directly on the filament or indirectly using non-contact methods. Alternatively, the conductivity and degree of tangle measurements may be performed indirectly by measuring another property of the filament, electrolyte or the detailed behavior of the voltpattern thereby providing a proxy measurement of the filament conductivity and degree of detangle.

A filament might be composed of nanoscale, mircorscale and macroscale components. Nanotubes, nanowires and nanoparticles in conjunction with microscale and/or macroscale constituents of a filament may also be affected by the ion infusion technology. One or more electrolytes, properly chosen, may enhance the detangle of all scale sizes present in the filament. Additionally, appropriate voltpattern may enhance the detangle of all scale sizes present in the filament. Finally, aligning techniques mentioned previously could enhance the detangle of the all scale sizes present in the filament.

### 4. Examples

As an example of one possible embodiment, the electrodes might be composed of CNTs and the electrolyte could be hydrochloric acid (HCl) that is not reactive with CNTs although HCl slightly dissolves CNTs under certain conditions. In this example the electrode filament holders could be made from ABS plastic as it is impervious to HCl.

Boron nitride nanotubes (BNNTs) are another example of nanotubes that are generally tangled through the fabrication and subsequent handling. In direct analogy with CNTs, BNNTs can be affected by ion infusion techniques to detangle the individual nanotubes. Strength increases for BNNT filaments and the subsequent threads and structures made from them are expected as alignment of the constituent nanotubes increases. Moreover, alignment techniques like those proposed for CNTs may also work for aligning BNNTs. All forms of BNNTs are insulators so the conductivity increases are not expected with increased alignment of BNNTs.

Geometrical shape and chemical bonding attributes of some nanoparticles, particularly non-spherically shaped nanoparticles could enhance tangle. Examples of oddly-shaped nanoparticles include, but are not limited to dumbbell and flower shapes.

### 5. How to Use the Invention

The problems in increasing the tensile strength properties of a filament formed from nanotubes, nanowires and/or nanoparticles as well as any thread or structures subsequently formed from the filament are well known to those skilled in the art and are best illustrated by considering the case of CNTs. In this case, the best mode configuration of the invention can be used in the laboratory to produce aligned and ordered filaments of relatively short lengths, limited by the maximum electrode length that the specific equipment enables. These filaments represent more aligned and ordered structures and possess increased conductivity. Thus these filaments can be removed, and formed into thread by twisting or other structures by processing. Then the filaments, threads or processed structures may be used for the following: material property testing; developing enhanced strength material samples; constructing enhanced strength structures; enhanced conductivity conductors, wires, microscale and nanoscale integrated circuits, microscale and nanoscale transistors, diodes, gates, switches, resistors, capacitors, sensors and other electrical components.

The inventor envisions transforming the present invention into an industrial process in which a vast number of nanotubes, nanowires and/or nanoparticles are continuously processed into aligned and ordered filaments. The resulting filaments would then be used for the industrial scale production of enhanced strength materials and structures and enhanced conductivity components as enumerated previously.

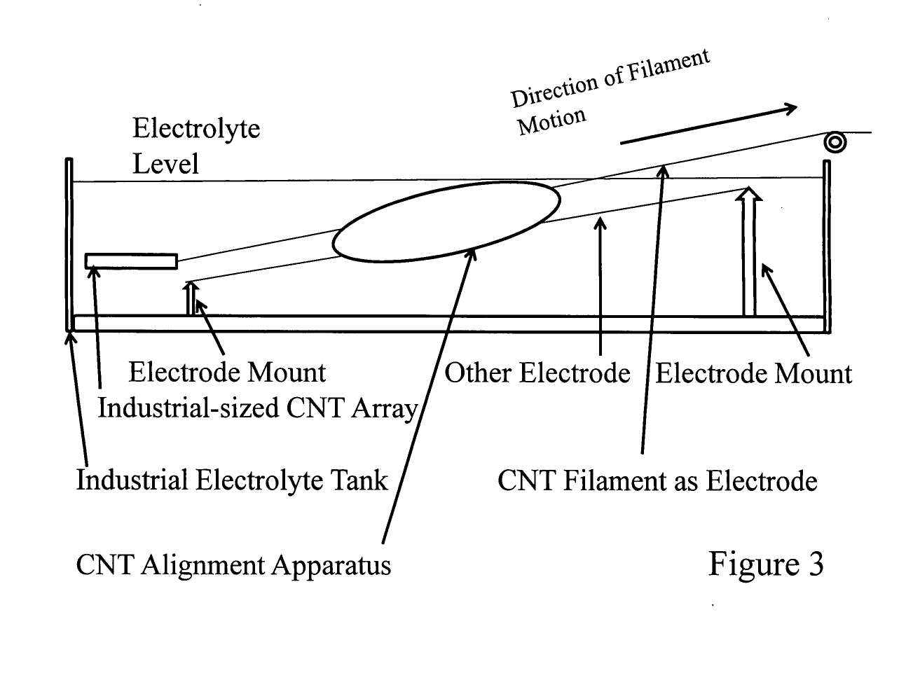

One possible embodiment of this vision is illustrated in FIG. 3. The nanotube, nanowire and/or nanoparticle arrays are submerged at one end of a reservoir of electrolyte. Filaments are drawn, initially by using a conducting probe but later as a continuing filament, from the arrays and travel through the electrolyte. Voltage applied, to the filament (initially to each probe but once the draw is established through a contact) and another electrode (submerged and mounted near the filament in the reservoir), establishes the current and initiates the ion infusion from the surrounding electrolyte. The filament may pass into regions of the electrolyte in which an alignment enhancement apparatus (or more than one) is operating. When the ion infusion is completed the filament exits the reservoir and is either spun into thread or gathered by mechanical means for further processing. The process runs continuously and can be scaled up to any size desired.

A new high strength material, possibly exceeding in tensile strength all existing materials by an order of magnitude or more, will revolutionize life on Earth. Additionally, electrical components created at the nanometer scale lengths will enable smaller, lower power integrated circuits and will transform human society. The most extreme example of the benefits may be that high strength CNTs will enable the Space Elevator, thereby opening the resources of space to mankind in the form of enhanced Earth observation, space-based solar power, asteroid mining, planetary defense and colonization of the moons and planets of our solar system!

It will be appreciated by those skilled in the art that the present invention is not restricted to the particular preferred embodiments described with reference to the drawings, and that variations may be made therein without departing from the scope of the present invention as defined in the appended claims and equivalents thereof.

What is claimed is:

1. A Nanotube Detangler, comprising: two electrodes, one or both of which are composed of a filament of tangled nanotubes, nanowires and/or nanoparticles; an electrolyte solution into which the electrodes are placed; and a voltage source, used to apply a voltpattern, connected between the two electrodes; wherein electrolyte ions are driven into the tangled nanotube filament(s) and detangle the constituent nanotubes, nanowires and/or nanoparticles.

2. A Nanotube Detangler according to claim 1, wherein a separate reference electrode and/or other diagnostic equipment is used to provide measurements of the process.

3. A Nanotube Detangler according to claim 1, wherein any appropriate electrolyte or combination of electrolytes are used including all types of acids and all types of salts that are dissolved into the appropriate solvents for each acid and salt.

4. A Nanotube Detangler according to claim 1, wherein any appropriate electrolyte or combination of electrolytes are used to optimize the detangle of the nanotubes, nanowires and/or nanoparticles.

5. A Nanotube Detangler according to claim 1, wherein a voltpattern is applied between the electrodes to optimize the detangle of the nanotubes, nanowires and/or nanoparticles.

6. A Nanotube Detangler according to claim 1, wherein an alignment enhancement technique is used to align and order the detangled nanotubes, nanowires and/or nanoparticles.

7. A Nanotube Detangler according to claim 6, wherein mechanically stretching and relaxing the filaments and/or applying vibrations to the filaments such as sound, infrasound, ultrasound and pressure waves in the electrolyte or a combination of these is used to further detangle, align and order the detangled nanotubes, nanowires and/or nanoparticles.

8. A Nanotube Detangler according to claim 6, wherein static or time varying electric fields; static or time varying magnetic fields; laser induced electromagnetic fields; or a combination of these, whether separate or inclusive of the voltpattern circuit; are used to further detangle, align and order the detangled nanotubes, nanowires and/or nanoparticles.

9. A Nanotube Detangler according to claim 6, wherein microscopic, molecular, atomic, electron and subatomic particle bombardment or a combination of these is used to further detangle, align and order the detangled nanotubes, nanowires and/or nanoparticles.

10. A Nanotube Detangler according to claim 6, wherein chemical reactions are used to further detangle, align and order the detangled nanotubes, nanowires and nanoparticles.

11. A Nanotube Detangler according to claim 6, wherein heating or cooling, including heating or cooling of the electrolyte, heating or cooling of the electrode, laser induced heating, electromagnetically induced heating or a combination of these is used to align and order the detangled nanotubes, nanowires and/or nanoparticles.

12. A method for using a Nanotube Detangler comprising the following steps: 1) mounting a nanotube, nanowire or nanoparticle filament on a mount; 2) configuring that mounted filament as an electrode by electrical connection to a voltage source, arranging the filament and its holder in an electrolyte; 3) arranging another electrode in the electrolyte; 4) applying a voltpattern to the electrodes; 5) once the voltpattern is completed removing the filament and its holder from the electrolyte; 6) demounting the filament from its mount; 7) processing and/or measuring properties of the filament; 8) and/or using the filament as a product.

13. A method for using a Nanotube Detangler, according to claim 12, wherein the step: arranging another electrode in the electrolyte, comprises the steps: 1) mounting a nanotube, nanowire or nanoparticle filament on a mount; 2) configuring that mounted filament as an electrode by electrical connection to a voltage source; 3) arranging the filament and its holder in an electrolyte.

14. A method for using a Nanotube Detangler, according to claim 12, further comprising the following step: applying, during the voltpattern step, an alignment enhancement technology, used to align and order the detangled nanotubes, nanowires and/or nanoparticles.

15. A method for using a Nanotube Detangler, according to claim 12, in which some or all of the steps may be repeated, including repeating the steps using different voltpatterns, or different electrolytes, or different electrodes, or different alignment enhancement technologies, or combinations of these different components to achieve an optimal amount of detangle.

16. A Nanotube Detangler wherein the detangle, including detangle enhanced by use of an alignment enhancement technique, increases the conductivity of the resulting filament, enabling its use in making electrical conductors, electrical components, electrical circuits, electrical systems and/or sensors.

17. A Nanotube Detangler according to claim 16, wherein the conductivity of the filament is tuned to certain value so that the filament, or subsequent threads or structures made from the filament, possess a desired conductivity.

18. A Nanotube Detangler according to claim 6, wherein the conductivity of the filament is measured either intermittently or continuously throughout the detangle operation to determine the filament's conductivity and to gauge the degree of detangle.

19. A Nanotube Detangler according to claim 18, wherein the conductivity and degree of detangle measurements are performed directly on the filament or indirectly using non-contact methods.

20. A Nanotube Detangler according to claim 18, wherein the conductivity and degree of tangle measurements are performed indirectly by measuring another property of the filament, electrolyte or the detailed behavior of the voltpattern thereby providing a proxy measurement of the filament conductivity and degree of detangle.
